(19) United States
(12) Patent Application Publication
(10) Pub. No.: US 2020/0390095 A1
(43) Pub. Date: Dec. 17, 2020

(54) USE OF ERYTHRITOL OR COMPOSITIONS COMPRISING SAME AS MAMMAL-SAFE INSECTICIDES

(71) Applicant: Drexel University, Philadelphia, PA (US)

(72) Inventors: Daniel A. Marenda, Elkins Park, PA (US); Sean O'Donnell, Swarthmore, PA (US)

(21) Appl. No.: 16/919,440

(22) Filed: Jul. 2, 2020

Related U.S. Application Data
(63) Continuation of application No. 15/301,008, filed on Sep. 30, 2016, now abandoned.
(60) Provisional application No. 61/974,528, filed on Apr. 3, 2014.
(60) Provisional application No. 62/007,641, filed on Jun. 4, 2014.

(51) Int. Cl. A01N 31/02; A01N 45/00

(52) U.S. Cl. CPC A01N 31/02; A01N 45/00

(57) ABSTRACT

The invention includes a mammal-safe method of killing or harming an insect. The method comprises administering to the insect a composition comprising erythritol ((2R,3S)-butane-1,2,3,4-tetraol).

### CROSS-REFERENCE TO RELATED APPLICATIONS

The present application is a continuation of U.S. patent application Ser. No. 15/301,008, filed Sep. 30, 2016, which is a 35 U.S.C. § 371 national phase application from, and claims priority to, International Application No. PCT/US2015/024224, filed Apr. 3, 2015, and published under PCT Article 21(2) in English, which claims priority under 35 U.S.C. § 119(e) to U.S. Provisional Patent Application No. 61/974,528, filed Apr. 3, 2014 and U.S. Provisional Patent Application No. 62/007,641 filed Jun. 4, 2014, the disclosures of which are incorporated herein by reference in their entireties.

### STATEMENT REGARDING FEDERALLY SPONSORED RESEARCH OR DEVELOPMENT

This invention was made with government support under grants number 1209072 and 1256114 awarded by National Science Foundation. The government has certain rights in the invention.

### BACKGROUND OF THE INVENTION

Insects have significant worldwide deleterious impact on human health, agriculture, and economic growth (McGraw, et al., Nat Rev Microbiol 11:181-193). The annual cost of application of insecticides for the prevention of insect damage has been estimated at $10 Billion in the US alone (Pimentel, et al., 2005, Environment, Development and Sustainability 7:229-252). Further, widespread use of toxic insecticides continues to pose a significant threat to human health, as highlighted by recent deaths in Bihar, India (Subramanian, et al., 2013, The New York Times). Many synthetic insecticides suffer drawbacks including high production costs, concern over environmental sustainability, harmful effects on human health, unintended targeting of insect species, and the evolution of resistance among insect populations.

There is thus great need in the art for the identification of cost-effective and human-safe insecticides to control insect pest populations. The present invention addresses and meets this need.

### BRIEF SUMMARY OF THE INVENTION

The invention provides compositions, kits and methods for killing or impairing an insect. The invention further provides compositions, kits and methods for impairing the motor function of an insect.

In certain embodiments, the method comprises administering to the insect a composition comprising an effective amount or concentration of erythritol [(2R,3S)-butane-1,2,3,4-tetraol], wherein the composition is not substantially toxic when administered to a mammal. In other embodiments, the administration comprises oral administration. In yet other embodiments, the administration is oral. In yet other embodiments, the composition further comprises at least one additive. In yet other embodiments, the additive is at least one odorant, peptide, protein or sodium salt.

In certain embodiments, the composition comprises TRUVIA. In other embodiments, the composition consists essentially of erythritol. In yet other embodiments, the composition consists of erythritol. In yet other embodiments, the composition comprises at least one selected from the group consisting of water, cornmeal, yeast, agar and erythritol. In yet other embodiments, the composition comprises water, cornmeal, yeast, agar and erythritol.

In certain embodiments, the composition further comprises at least one sugar, sweetener or sugar-containing composition or sugar derivative that is not toxic to the insect. In other embodiments, the at least one sugar comprises molasses, sucrose, glucose or fructose. In yet other embodiments, the composition comprises water, cornmeal, yeast, molasses, agar and erythritol. In yet other embodiments, the concentration of erythritol in the composition ranges from about 0.1M to 10M. In yet other embodiments, the concentration of erythritol in the composition ranges from about 0.5M to 5.0M. In yet other embodiments, the concentration of erythritol in the composition ranges from about 0.5M to 2.0M.

In certain embodiments, the mammal is human. In other embodiments, the insect is at least one selected from the group consisting of flies, moths, beetles, bees, wasps, yellow jackets, ants, cockroaches, bed bugs, and silverfish. In yet other embodiments, the insect comprises a fly.

In certain embodiments, the composition comprises erythritol and at least one additive, wherein the composition is not substantially toxic when administered to a mammal. In other embodiments, the concentration of erythritol in the composition ranges from about 0.1M to 10M. In yet other embodiments, the additive is at least one odorant, peptide, protein or sodium salt.

In certain embodiments, the kit comprises erythritol, an applicator, and an instructional material for use thereof, wherein the instructional material comprises instructions for killing or impairing an insect using the composition, without substantially harming a mammal.

### BRIEF DESCRIPTION OF THE DRAWINGS

For the purpose of illustrating the invention, certain embodiments of the invention are depicted in the drawings. However, the invention is not limited to the precise arrangements and instrumentalities of the embodiments depicted in the drawings.

FIG. 1 is a graph illustrating the finding that Drosophila melanogaster raised on food containing TRUVIA show decreased longevity. The graph illustrates percentage of living adult flies raised on food containing various nutritive sugars and non-nutritive sweeteners over time. Note significant decrease in longevity of adult flies raised on food containing TRUVIA compared to other food. 300 total flies were used in these experiments.

FIG. 2 is a graph illustrating the finding that Drosophila melanogaster raised on food containing TRUVIA show decreased motor behavior. The graph illustrates climbing ability of adult flies raised on food containing different nutritive sugars and non-nutritive sweeteners over time. There was significant decrease in climbing behavior of adult flies raised on food containing TRUVIA compared to other food. 300 total flies were used in these experiments.

FIG. 3 is a graph illustrating the finding that Drosophila melanogaster raised on food containing erythritol show decreased longevity. The graph illustrates percentage of living adult flies raised on food containing various nutritive sugars and non-nutritive sweeteners over time. There was significant decrease in longevity of adult flies raised on food containing either TRUVIA or erythritol compared to other food. 210 total flies were used for these experiments.

FIG. 4 is a graph illustrating the finding that increasing concentrations of erythritol show decreased longevity in Drosophila melanogaster. The graph illustrates percentage of living adult flies raised on food containing different concentrations of erythritol. Control food was 0.5M sucrose. 2M erythritol; 1M erythritol; 0.5M erythritol and 0.1M erythritol were tested. There was significant decrease in longevity of adult flies as concentration of erythritol was increased. 150 total flies were used for these experiments.

FIG. 5 is a graph illustrating the finding that Drosophila melanogaster ingest erythritol as often as they ingest sucrose in a two-way choice experiment. The graph illustrates percentage of living adult flies when given a choice between two different food sources throughout their lifespan. Negative control choice experiments provide 1M sucrose on both sides of choice chamber. Positive control choice experiments provide 1M erythritol on both sides of the choice chamber. Experimental groups provide 1M erythritol on one side of the choice chamber and 1M sucrose on the opposite side of the chamber; and 2M erythritol on one side of the choice chamber and 1M sucrose on the opposite side of the chamber. There was significant decrease in longevity in both experiments where erythritol is provided as a choice with sucrose. 120 total flies were used for these experiments.

FIG. 6 is a set of graphs illustrating distinct insecticidal effects of human-safe sweet alcohols. Results illustrate that flies fed non-nutritive alcohols other than erythritol (such as D-mannitol, maltitol, sucrose and xylitol) had significantly greater longevity than erythritol-fed flies, and did not differ from sugar control.

FIG. 7 is a table illustrating a list of artificial sweeteners and active compounds used in this study.

FIGS. 8A-8B are a set of images illustrating that blue food labeling indicated that Drosophila melanogaster consume food containing TRUVIA and other non-nutritive sweeteners. Illustrated are representative female (FIG. 8A) and male (FIG. 8B) flies with blue abdomens and proboscises (indicated by arrows in FIGS. 8A-8B).

### DETAILED DESCRIPTION OF THE INVENTION

The present invention relates to unexpected discovery of a novel method of killing or impairing an insect without substantially harming a mammal. The method comprises administering to the insect a composition comprising erythritol (also known as (2R,3S)-butane-1,2,3,4-tetraol). In certain embodiments, the composition is not substantially toxic when administered to a mammal. In one aspect of the invention, erythritol composition is safe to mammal, even in case of accidental consumption. In fact, erythritol was approved by US Food and Drug Administration (US FDA) in 2001 to be used as a food additive in US. It is well know that consumption of erythritol, even in high concentrations, is safe to humans. In certain embodiments, the mammal is human.

As disclosed herein, erythritol, the main component of the sweetener Truvia®, was unexpectedly found to be toxic when ingested by fruit flies as compared to similar concentrations of nutritive sugar controls (sucrose, corn syrup) and other non-nutritive sweeteners. The effects of erythritol and Truvia® on the longevity and motor function of the fruit fly, Drosophila melanogaster, are described herein. Erythritol reduced fly longevity in a concentration-dependent manner. Flies readily consumed erythritol when given free access to control (sucrose) food sources and suffered decreased longevity. Thus, erythritol and compositions thereof can be used as a novel, human-safe insecticide.

In certain embodiments, the composition comprises the non-nutritive sweetener TRUVIA®, which comprises erythritol. In other embodiments, the composition consists essentially of erythritol. In yet other embodiments, the composition consists of erythritol.

In certain embodiments, the effective concentration of erythritol in the composition ranges from about 0.1M to about 10M. In other embodiments, the effective concentration of erythritol in the composition ranges from about 0.5M to about 5.0M. In yet other embodiments, the effective concentration of erythritol in the composition ranges from about 0.5M to about 2M. One skilled in the art will be able to adjust the erythritol concentration in the composition according to the well-known methods in the literature, in order to control the efficiency and rate of killing of insects.

In certain embodiments, the composition further comprises at least one additive. In yet other embodiments, the additive comprises at least one odorant, peptide, protein or sodium salt.

In certain embodiments, the composition further comprises at least one sugar, sweetener or sugar-containing composition or sugar derivative that is not toxic to the insect. In yet other embodiments, the at least one sugar or sugar derivative comprises molasses, sucrose, glucose or fructose.

In certain embodiments, the composition of the invention further comprises at least one selected from the group consisting of water, cornmeal, yeast, and agar.

In certain embodiments, the composition of the invention comprises water, cornmeal, yeast, molasses, agar and erythritol. In other embodiments, the composition of the invention comprises water, cornmeal, yeast, agar and erythritol.

In certain embodiments, the insect comprises, but is not limited to, flies, bees, beetles, moths, wasps, yellow jackets, ants, cockroaches, bed bugs, and/or silverfish. In other embodiments, the insect comprises a fly. In yet other embodiments, the fly belongs to the Drosophila genus. In yet other embodiments, the fly comprises D. melanogaster, D. immigrans, D. simulans, D. subobscura, Zaprionus indianus, D. bifurca, D. sechellia, D. yakuba, D. erecta, D. ananassae, D. suzukii, D. pseudoobscura, D. persimilis, D. willistoni, D. mojavensis, D. virilis or D. grimshawi.

### Definitions

Unless defined otherwise, all technical and scientific terms used herein have the same meaning as commonly understood by one of ordinary skill in the art to which the invention pertains. Although any methods and materials similar or equivalent to those described herein may be used in the practice for testing of the present invention, the preferred materials and methods are described herein. In describing and claiming the present invention, the following terminology will be used.

It is also to be understood that the terminology used herein is for the purpose of describing particular embodiments only, and is not intended to be limiting.

As used herein, the articles “a” and “an” are used to refer to one or to more than one (i.e., to at least one) of the grammatical object of the article. By way of example, “an element” means one element or more than one element.

As used herein when referring to a measurable value such as an amount, a temporal duration, and the like, the term “about” is meant to encompass variations of ±20% or ±10%, more preferably ±5%, even more preferably ±1%, and still more preferably ±0.1% from the specified value, as such variations are appropriate to perform the disclosed methods.

As used herein, the term “effective concentration” or “effective amount” as relating to erythritol refers to the concentration or amount of erythritol in the composition which is sufficient to impair or kill insects when administered to them.

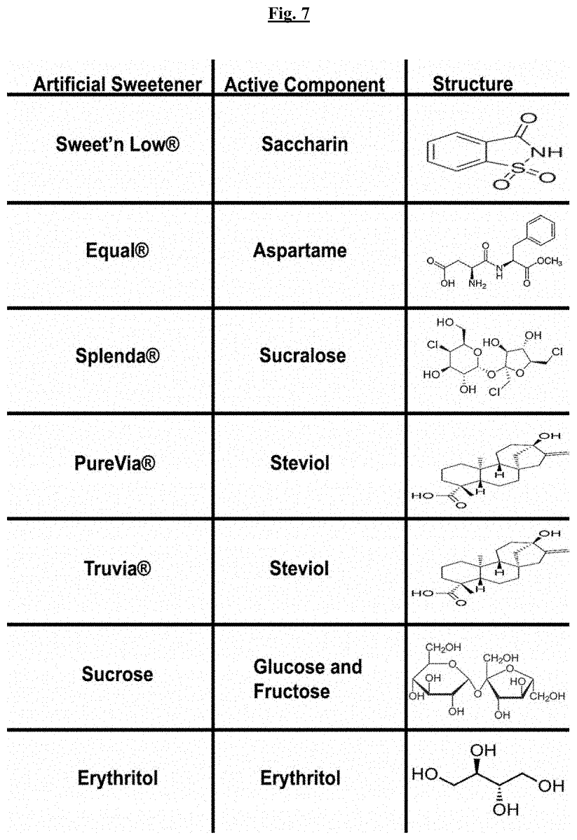

As used herein, the term “EQUAL” refers to a non-nutritive sweetener, comprising dextrose, aspartame, acesulfame potassium, starch, silicon dioxide (an anti-caking agent), maltodextrin, and unspecified flavouring, sold under the trademark EQUAL®. The chemical structure of its sweetening ingredient is illustrated in FIG. 7.

As used herein, the term “impair” refers to the ability to disrupt to a measurable degree the metabolism, feeding, defense, aggression, reproduction and/or mobility of an organism, such as, but not limited to, an insect.

As used herein, the term “M” refers to molar concentration, which is defined as the amount of a constituents in moles divided by the volume of the composition.

As used herein, the term “PUREVIA” refers to a non-nutritive sweetener, comprising dextrose, cellulose powder, and natural flavors, as well as the stevia extract rebaudioside A, which is sold under the trademark PUREVIA®. The chemical structure of its sweetening ingredient is illustrated in FIG. 7.

As used herein, the term “TRUVIA” refers to a non-nutritive sweetener, comprising erythritol, stevia leaf extract, and natural flavors, which is sold under trademark TRUVIA®. The chemical structure of its sweetening ingredient is illustrated in FIG. 7.

As used herein, the term “SPLENDA” refers to a sucralose-based artificial sweetener derived from sugar, which is sold under the trademark SPLENDA®. The chemical structure of its sweetening ingredient is illustrated in FIG. 7.

As used herein, the term “substantially toxic” to an organism refers to a substance or compound that causes significant damage or health threat to the organism. In certain embodiments, the substantially toxic substance or compound disrupts or interferes with the health and/or well-being of the organism, disables the organism, prevents the organism from performing usual and expected activities, and/or kills the organism.

A “subject,” or “individual” or “patient,” as used therein, may be a human or non-human mammal. Non-human mammals include, for example, livestock and pets, such as ovine, bovine, porcine, canine, feline and murine mammals. Preferably, the subject is human.

As used herein, the term “SWEET'N'LOW” refers to an artificial sweetener made primarily from granulated saccharin, sold under trademark SWEET'N'LOW®. The chemical structure of its sweetening ingredient is shown in FIG. 7.

### Kits:

The invention includes a kit comprising a composition comprising erythritol, an applicator, and an instructional material for use thereof. The instructional material included in the kit comprises instructions for killing or impairing an insect without substantially harming a mammal. The instructional material recites the amount of, and frequency with which, the composition should be contacted with the insect for its consumption by the insect. In other embodiments, the kit further comprises at least one additional agent that kills or impairs the insect. In other embodiments, the kit further comprises at least one sugar, sweetener or sugar-containing composition or sugar derivative that is not toxic to the insect.

Those skilled in the art will recognize, or be able to ascertain using no more than routine experimentation, numerous equivalents to the specific procedures, embodiments, claims, and examples described herein. Such equivalents were considered to be within the scope of this invention and covered by the claims appended hereto. For example, it should be understood, that modifications in reaction conditions, including but not limited to reaction times, reaction size/volume, and experimental reagents, such as solvents, catalysts, pressures, atmospheric conditions, e.g., nitrogen atmosphere, and reducing/oxidizing agents, with art-recognized alternatives and using no more than routine experimentation, are within the scope of the present application.

It is to be understood that wherever values and ranges are provided herein, all values and ranges encompassed by these values and ranges, are meant to be encompassed within the scope of the present invention. Moreover, all values that fall within these ranges, as well as the upper or lower limits of a range of values, are also contemplated by the present application.

The invention is now described with reference to the following materials and methods. These materials and methods are provided for the purpose of illustration only, and the invention is not limited to these experiments, but rather encompasses all variations that are evident as a result of the teachings provided herein.

### EXAMPLES

### Methods

### Drosophila Culturing and Sample Sizes:

All animals were cultured at 25° C., kept at 50-60% humidity, and were raised under a standard 12:12 light dark cycle. For each experimental treatment, n=30 flies were tested in groups of 10 per tube, and three tubes per treatment. Tubes were kept on their side to minimize subject becoming mired in the food. Foods were replaced twice a week. The total number of fruit flies used for these experiments was 780, with 300 used for two initial trials testing mortality among store-brand sweeteners, 210 used for repeating this with blue dye and pure erythritol, 120 for choice trials and 150 for concentration trials.

Standard Drosophila food for larval culturing consisted of water, cornmeal, yeast, molasses, and agar, as previously described (Chakraborty, et al., 2011, PLoS ONE 6: e20799). A similar food (without molasses) also served as the base to which treatments were added. The addition of cornmeal and yeast assured the flies still received sufficient carbohydrates and protein in addition to any effects of the treatment additives.

Drosophila food was combined with an equal weight/volume (0.0238 g/ml) of one non-nutritive sweetener (TRUVIA, EQUAL, SPLENDA, SWEET'NLOW, or PUREVIA) or a control nutritive sweetener (controls: sucrose or corn syrup). Wild type (Canton S) larvae were initially raised on the standard food, and 0-12 hour old adult flies were transferred to foods containing one non-nutritive sweetener or a control treatment. The longevity of flies raised on food containing an equal weight/volume (0.0238 g/ml) of each of these sweeteners were compared to control foods. Experimenters were blinded to treatments when assessing mortality and climbing ability. The exception was corn syrup, as it is not a white solid and can therefore be texturally discerned. 0-24 hour-old Drosophila were placed on these foods and observed for 65 days. This procedure was repeated with foods containing brilliant blue FCF (Fisher 50-727-25) in 5% weight/volume concentration (Wong, et al., 2009, PLoS One 4: e6063), as well as erythritol, sucrose, corn syrup, TRUVIA, EQUAL or PUREVIA as treatments. Flies were then examined daily for externally visible blue guts. Longevity assays and climbing behavioral assays were performed as previously described (Chakraborty, et al. 2011, PLoS ONE 6: e20799). The number of dead flies were scored daily. Climbing behavior was assayed every second day. For climbing assays, a modified version of Le Bourg and Lints was used (Le Bourg, 1992, Gerontology 38: 71-79). Groups of 10 or fewer flies were transferred to a clean, empty vial and given 18 seconds to climb 5 cm. The number of flies that successfully reach the 5 cm line were recorded.

### Concentration Trials:

Standard fly foods were prepared as previously described, and then were treated with 2M, 1M, 0.5M and 0.1M concentrations of erythritol, using 0.5M sucrose as control. 0 to 24 hour-old Drosophila were placed on these foods and mortality was recorded daily for 35 days as above.

### Choice Experiments:

Foods containing 2 M erythritol, 1M erythritol and 1M sucrose were prepared for paired presentations in open choice tests. In each treatment one food type contained 0.05% brilliant blue FCF (Fisher 50-727-25). The blue dye allowed visual confirmation of feeding on the dyed food in the pair. The flies were presented with access to two food choices by using a modified cotton stopper with approximately a 1.5 cm diameter hole to connect each pair of food tubes.

Three choice trial groups were set up: the first was between blue 1M erythritol and non-blue 1M erythritol foods (blue guts would confirm the blue dye did not inhibit feeding and confirm erythritol was being consumed), the second was between blue 1M erythritol and non-blue 1M sucrose foods (blue guts would confirm erythritol was being consumed in the presence of sucrose), and the third was a choice between blue 1M sucrose and non-blue 1M sucrose, as a negative control (blue guts would confirm the blue dye did not inhibit feeding). The final choice treatment was between blue 2M erythritol food and non-blue 1M sucrose food (this treatment provides a comparison with the 1 M erythritol/1 M erythritol treatment as a test of dilution of toxicity by alternative food sources; blue guts would confirm erythritol was being consumed in the presence of sucrose). The number of flies with visible blue gut contents and mortality daily were recorded for 30 days.

### Statistics:

Analyses were conducted with SPSS software v. 20 (IBM corporation 2011). Fly longevity data were analyzed using survival analysis with right-hand censoring of subjects that lived to the end of the study or were lost for reasons other than death. Test were run for differences in survival distributions [Pr(flies alive) versus insect age] using the log-rank (Mantel-Cox) test to make all pairwise comparisons among treatments within each experiment.

Differences among treatments in the percent of living flies that succeeded in the climbing assay on day seven were tested using Fisher's exact test (two-tailed).

The following results and discussion further illustrate aspects of the present invention. However, they are in no way a limitation of the teachings or disclosure of the present invention as set forth herein.

### Example 1: Comparisons of Effects of Non-Nutritive Sweeteners

The effects of adding five different non-nutritive sugar substitutes (TRUVIA, EQUAL, SPLENDA, SWEET'NLOW, and PUREVIA; see FIG. 7 for the active non-caloric sweeteners and chemical structures in each sugar substitute) to standard lab culturing Drosophila food (Chakraborty, et al., 2011, PLoS ONE 6: e20799) were analyzed.

Adult flies raised on food containing TRUVIA showed a significant reduction in longevity (FIG. 1) compared to adult flies raised on control nutritive sweeteners (FIG. 1, both X²>76.0; both p<0.001), PUREVIA (FIG. 1, X²=76.3, p<0.001), and compared to other non-nutritive sweeteners (FIG. 1, all X²>73.0, all p<0.001). No other treatments differed significantly (all X²<3.4, all p>0.06) except Splenda vs. Sweet 'N Low (X²=6.1, p=0.01).

While the mean longevity for flies raised on control and experimental foods without TRUVIA was between 38.6+3.2SE and 50.6+2.9SE days, the mean longevity of flies raised on food containing TRUVIA was 5.8+0.3SE days.

### Example 2: Effects on Motor Coordination

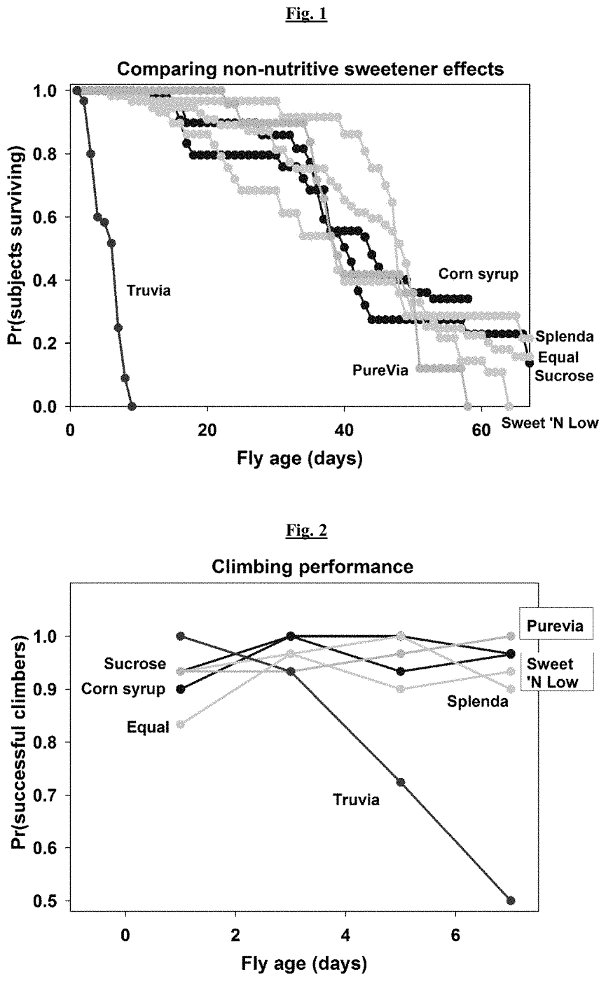

Adult flies raised on food containing TRUVIA displayed aberrant motor control prior to death. Motor reflex behavior was thus assayed through climbing assays. Flies raised on food containing TRUVIA showed a significantly decreased ability to climb by day 7 (FIG. 2) compared to flies raised on control nutritive foods (FIG. 2, Fisher's exact test, both p=0.0006), PUREVIA (FIG. 2, p<0.0001), and compared to other non-nutritive sweeteners (FIG. 2, all p<0.007). No other treatments differed from each other (all p>0.24).

Taken together with the longevity studies, these data suggested some component of the non-nutritive sweetener TRUVIA was toxic to adult Drosophila melanogster, affecting both motor function and longevity of this insect.

### Example 3: Tests of Erythritol as the Toxic Agent

The initial analysis of sweeteners included two sweeteners that contained extracts from the stevia plant, TRUVIA and PUREVIA (FIG. 7). While adult flies raised on food containing TRUVIA showed a significant decrease in longevity compared to controls, adult flies raised on food containing PUREVIA did not show a significant decrease in longevity compared to controls (both X²<1.1, both p>0.30, FIG. 1). These data suggest stevia plant extract was not the toxic element in these sweeteners. PUREVIA contains dextrose as a bulk component, while TRUVIA contains erythritol as a bulk component. Erythritol is a four-carbon polyol that is marketed as a non-nutritive sweetener (Moon, H., et al., 2010, Appl Microbiol Biotechnol 86:1017-1025) (FIG. 7).

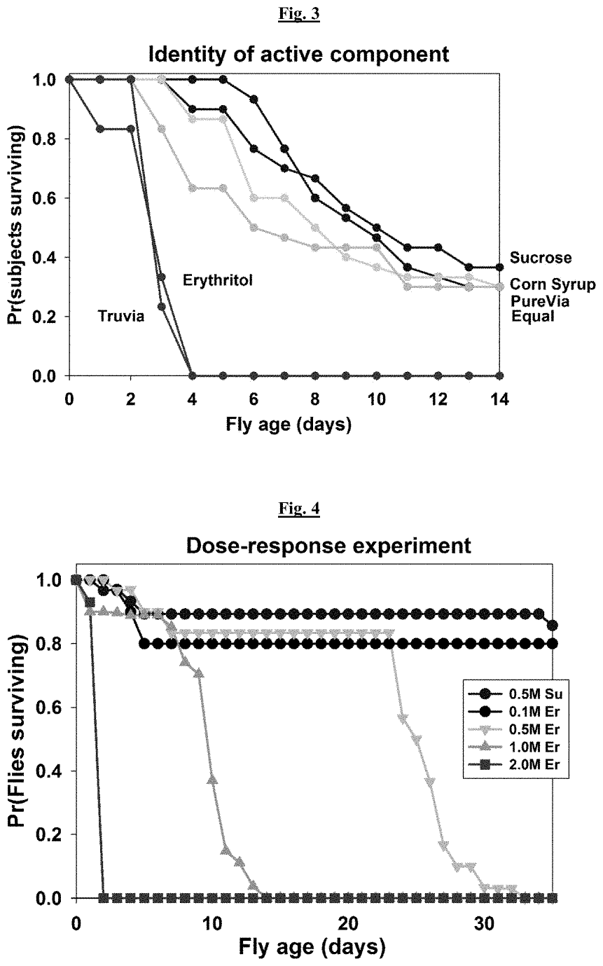

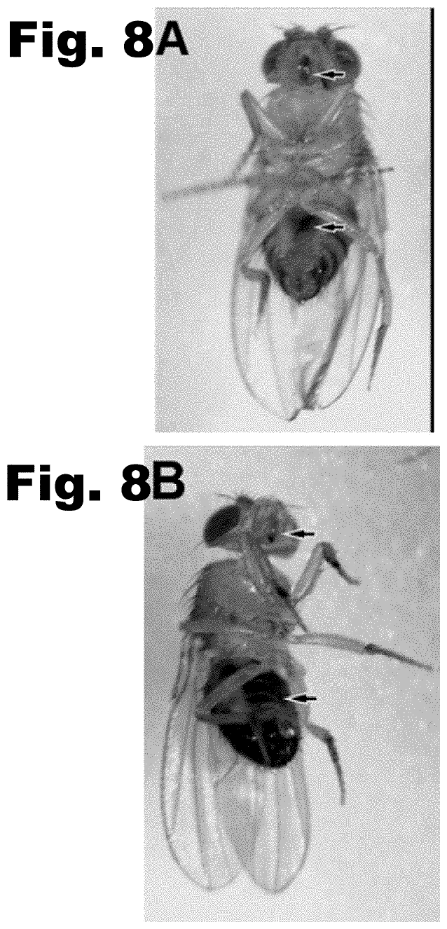

To determine if erythritol was the toxic component of TRUVIA, the longevity studies were repeated on food containing equal weight/volume (0.0238 g/ml) of nutritive sugar controls, TRUVIA, PUREVIA, EQUAL, and erythritol. The flies were successfully eating the foods containing these sweeteners through dye labelling the food with a non-absorbed blue dye (Wong, et al., 2009, PLoS One 4: e6063) (blue food), and visual confirmation of blue food present in fly abdomens and proboscises (FIGS. 8A-8B). All subject flies in all treatments had visibly blue abdomens throughout the study, confirming all treatment foods were consumed by adult flies, and suggesting mortality was not due to food avoidance and starvation. Adult flies raised on food containing both TRUVIA and erythritol (FIG. 3) showed similar significant decreases in longevity compared to adult flies that were raised on either PUREVIA (FIG. 3, both X²>31.4, both p<0.001) or EQUAL (FIG. 3, both X²>53.3, both p<0.001), or on the nutritive controls sucrose and corn syrup (FIG. 3, all X²>54.1, all p<0.001). Fly longevity did not differ between the erythritol and TRUVIA treatments (X²=0.013, p=0.91). These data suggest the erythritol within TRUVIA was the toxic component.

### Example 4: Dose-Response Analysis of Erythritol Effects on Fly Longevity

Previous analyses were performed using equal weight/volume concentrations (0.0238 g/ml) of nutritive and non-nutritive sweeteners. To assess the utility of erythritol as an insecticide, the longevity studies were repeated using erythritol at varying concentrations to determine erythritol's dose response.

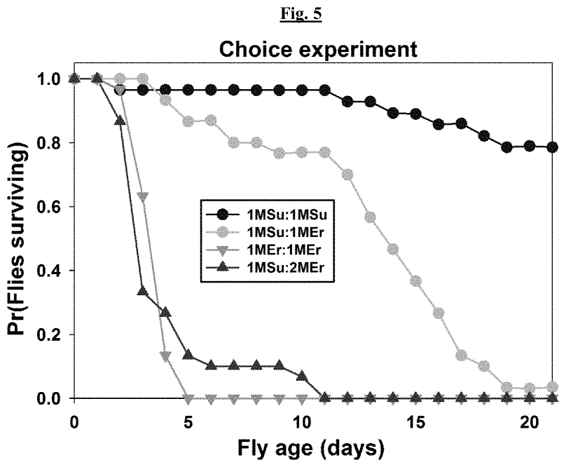

The effect of 0.1M, 0.5M, 1.0M and 2.0M erythritol-containing food on fly longevity was assessed. Adult flies showed a dose-dependent reduction in longevity when raised on food containing increasing concentrations of erythritol (FIG. 4). Food containing 2M concentrations of erythritol showed a significant and severe effect on longevity compared to all other treatments (all X²>37.6, all p<0.001), although 1M and 0.5M also showed significant reductions in longevity compared to flies raised on control food containing 0.5M sucrose (both X²>42.1, both p<0.001). Flies fed 0.5M erythritol lived longer than flies in the 1M erythritol treatment (X²=34.8, p<0.001). Flies raised on 0.1M erythritol showed no significant difference in longevity compared to flies raised on control food when observations were terminated at 35 days subject fly age. Taken together, these data suggest increasing dosage of erythritol reduced fly longevity according to concentration.

### Example 5: Palatability of Food Containing Erythritol

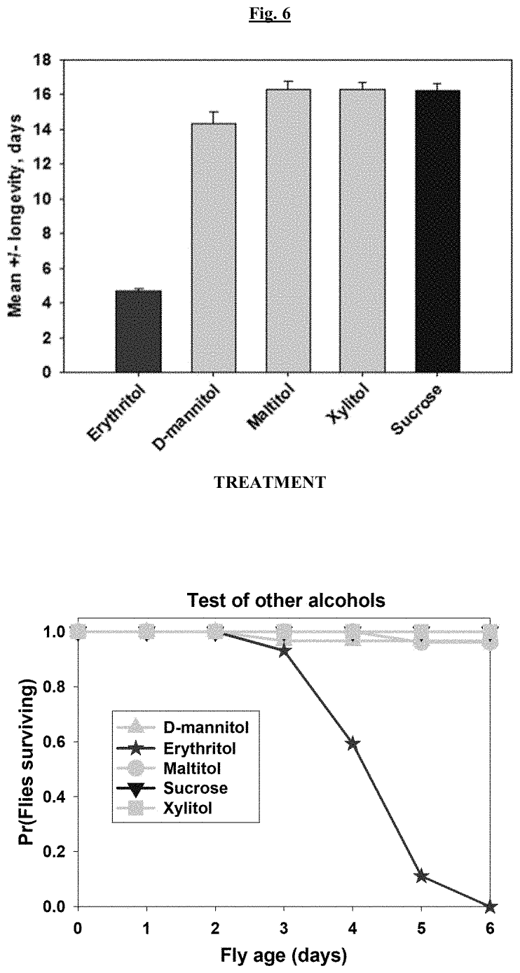

To determine if erythritol containing food was in some way repulsive to flies, two-way choice experiments were performed. Flies were provided with free access to two food sources: 1M sucrose control food, 1M erythritol, and 2M erythritol, and their longevity over time monitored. Blue dye in one food per choice trial was used to ensure that food was being taken up by the flies (see Methods). Flies with a choice between 1M sucrose and 1M erythritol had significantly decreased longevity relative to sucrose: sucrose choice (X²=37.5, p<0.001; FIG. 5). Longevity was also significantly reduced when we provided the flies with a choice between 1M sucrose and 2M erythritol (X²=60.5, p<0.001; FIG. 5).

Taken together, the data show that flies consumed foods containing erythritol when given access to sucrose-containing (control) food. Though amounts of food consumed by flies in the studies was not quantified, one pattern in the food choice data suggests flies found erythritol-containing food equally attractive to sucrose (control) food: the survival distributions were nearly identical between our 2M erythritol/1M sucrose choice treatment and our 1M erythritol/1M erythritol treatment (X²<0.00, p=0.996; FIG. 5). This pattern is consistent with expectations if flies consumed sucrose and 2M erythritol foods in roughly equal amounts, effectively diluting the erythritol concentration by half (to 1M erythritol). In any case, the choice experiments showed flies will consume food with erythritol when given access to other food sources, and suffer increased mortality as a result. Thus, erythritol baits can function as an effective insecticide delivery mechanism when presented in naturalistic situations where insects have access to other foods.

### Example 6: Comparison of Erythritol with Other Human-Safe Sweet Alcohols

An experiment was conducted to compare the effectiveness of erythritol with other human-safe sweet alcohols: D-mannitol, maltitol, sucrose, and xylitol. The concentration of all sweet alcohols were 1M.

Flies were raised for 17 days on standard fly food that contained 1 M concentrations of each sweetener treatment. Death of flies was recorded daily as before; each treatment was replicated on three vials of 10 flies each for 30 subjects/treatment. Differences in longevity were analyzed using the Kaplan-Meier survival analysis log rank test, making all pairwise comparisons among treatments.

Fly longevity in the erythritol treatment (mean 4.7±0.15 SE days) was significantly lower than fly longevity for all other treatments (means 14.3-16.3 days, all X²>52.5, all p<0.001). Compared to sucrose (positive control), D-mannitol fed flies had slightly but significantly reduced longevity (p=0.004); other sweeteners did not differ from the control (maltitol p=0.86, xylitol p=0.96).

These data confirm the insecticidal activity of erythritol. The data further indicate that=D-mannitol has almost insignificant insecticidal effect, and xylitol and maltitol were not effective at reducing fly longevity across 17 days of exposure. Thus, erythritol, but not the other sweeteners tested herein, is toxic to fruit flies upon ingestion.

As illustrated in FIG. 6, erythritol-fed flies had significantly shorter longevity than flies fed several other non-nutritive alcohols. Also, the longevity of flies fed several other non-nutritive alcohols did not differ from sugar control.

The findings recited herein demonstrate, for the first time, that erythritol, and the erythritol containing sweetener TRUVIA, are toxic to Drosophila melanogaster. This result is surprising because erythritol is not known to be toxic to arthropod tissue. For example, insects seasonally exposed to freezing conditions often produce erythritol and other polyhydric alcohols as tissue cryoprotectants (Danks, et al., 2004, Integr Comp Biol 44:85-94; Kostal, 2007, J Insect Physiol 53:580-586). Larvae of one antarctic midge can safely ingest erythritol from food plants and sequester it for adult cryoprotection (Baust, et al., 1979, Physiological Entomology 4:1-5).

Erythritol consumption by humans is very well tolerated (Tetzloff, et al., 1996, Regul Toxicol Pharmacol 24:S286-295; Oku, et al., 1996, Nutrition Research 16:577-589; Bornet, 1996, Regul Toxicol Pharmacol 24:S296-302), and indeed, large amounts of both erythritol and TRUVIA are being consumed by humans every day throughout the world. Taken together, the data indicate that erythritol is a novel, effective, and human safe approach for insect pest control. For example, this compound may be used in targeted bait presentations to fruit crop and urban insect pests.

The disclosures of each and every patent, patent application, and publication cited herein are hereby incorporated herein by reference in their entirety.

While the invention has been disclosed with reference to specific embodiments, it is apparent that other embodiments and variations of this invention may be devised by one skilled in the art without departing from the true spirit and scope of the invention. The appended claims are intended to be construed to include all such embodiments and equivalent variations.

What is claimed is:

1. A method of killing or impairing reproduction in an insect, the method comprising:
administering to the insect a composition comprising an effective amount or concentration of erythritol [(2R,3S)-butane-1,2,3,4-tetraol],
wherein the composition is not substantially toxic when administered to a mammal, and
wherein the insect is at least one selected from the group consisting of flies, moths, beetles, bees, wasps, yellow jackets, cockroaches, bed bugs, and silverfish.

2. The method of claim 1, wherein the composition further comprises at least one additive.

3. The method of claim 2, wherein the additive is at least one odorant, peptide, protein or sodium salt.

4. The method of claim 1, wherein the composition comprises water.

5. The method of claim 1, wherein the composition further comprises at least one sugar, sweetener, sugar-containing composition, or sugar derivative that is not toxic to the insect.

6. The method of claim 5, wherein the at least one sugar comprises molasses, sucrose, glucose or fructose.

7. The method of claim 1, wherein the concentration of erythritol in the composition ranges from about 0.1M to 10M.

8. The method of claim 7, wherein the concentration of erythritol in the composition ranges from about 0.5M to 5.0M.

9. The method of claim 8, wherein the concentration of erythritol in the composition ranges from about 0.5M to 2.0M.

10. The method of claim 1, wherein the mammal is human.

11. The method of claim 1, wherein the insect comprises a fly.

12. The method of claim 11, wherein the fly is from the Drosophila genus.

13. The method of claim 12, wherein the fly is a species selected from the group consisting of D. melanogaster, D. immigrans, D. simulans, D. subobscura, D. bifurca, D. sechellia, D. yakuba, D. erecta, D. ananassae, D. suzukii, D. pseudoobscura, D. persimilis, D. willistoni, D. mojavensis, D. virilis, and D. grimshawi.

14. The method of claim 13, wherein the fly is D. suzukii.
